(19) United States
(12) Patent Application Publication
(10) Pub. No.: US 2005/0191161 A1
(43) Pub. Date: Sep. 1, 2005

(54) Lift with active opener arm

(76) Inventors: Karapet Ablabutyan, Glendale, CA (US); Akop Gasparian, Panorama, CA (US)

Correspondence Address: MANATT PHELPS AND PHILLIPS;ROBERT D. BECKER, 1001 PAGE MILL ROAD, BUILDING 2, PALO ALTO, CA, 94304, US

(21) Appl. No.: 10/789,909

(22) Filed: Feb. 27, 2004

(51) Int. Cl. B60P 1/00

(52) U.S. Cl. 414/557

(57) ABSTRACT

A lift having an active opener arm is described. The active opener arm assists a user in stowing and unstowing the lift platform. The active opener arm is capable of receiving the platform from the user when the platform is being stowed and lowering the platform onto the parallelogram linkage. The active opener arm is also capable of lifting the platform off of the parallelogram linkage when the platform is being unstowed and making the platform more accessible to the user.

### BACKGROUND OF THE INVENTION

1. Field of the Invention

The present invention relates to lifts for lifting and lowering loads to and from vehicle. More particularly, the present invention relates to an apparatus and method for facilitating the stowing and unstowing of folding lifts.

2. Description of Related Art

Lifts raise and lower loads to and from vehicles. Lifts may be mounted to the back or a side of a vehicle, and typically raise and lower a load-carrying platform between the ground and a vehicle bed. Lifts may have lift arms configured in a parallelogram arrangement which maintain the platform in a substantially horizontal orientation through the entire lifting range.

Lifts may be designed to be stowed when not in use. “Tuck under” style lifts stow the platform underneath the vehicle when not in use. These lifts may use a segmented platform that includes a “flipover.” To stow the platform, the lift arms may be lowered and then the platform folded onto the lift arms. When the lift arms are raised again, the platform is then stowed. To unstow the platform, the lift arms may be lowered, and then the platform unfolded off of the lift arms. The lift is then be ready for use.

“Tuck under” style lifts may be difficult for a user to fold and unfold, especially in vehicle beds with low ground clearance. Typically, the lower the vehicle bed, the farther in under the vehicle body the user will have to reach. This may result in strain or injury.

What is needed is a way to make a “tuck under” style platform easier for a user to fold unfold.

### BRIEF DESCRIPTION OF THE DRAWINGS

FIG. 1 shows one embodiment of a lift of the present invention having an active opener arm.

FIGS. 2A-2E show operation of one embodiment of a lift of the present invention.

FIGS. 3A-3E show side views of isolated elements of one embodiment of a lift of the present invention.

### DETAILED DESCRIPTION OF THE INVENTION

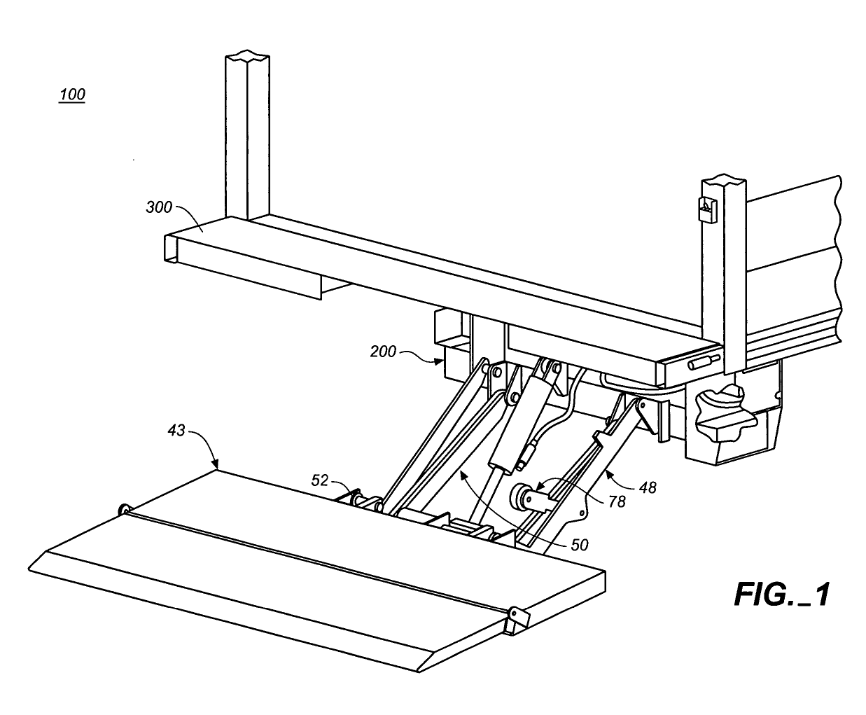

FIG. 1 shows one embodiment of a lift 100 of the present invention having an active opener arm 78. Lift 100 includes an upper arm 48, a lower arm 50, a shackle 52, a platform 43, and an active opener arm 78.

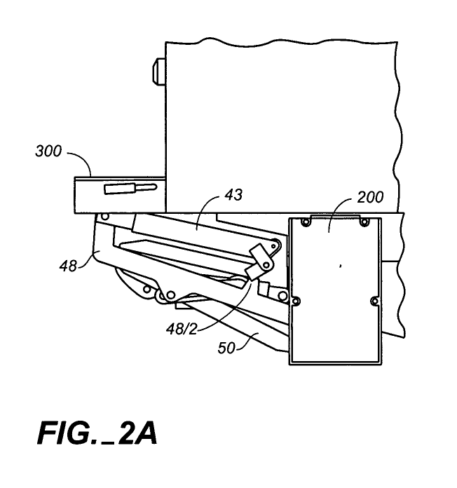

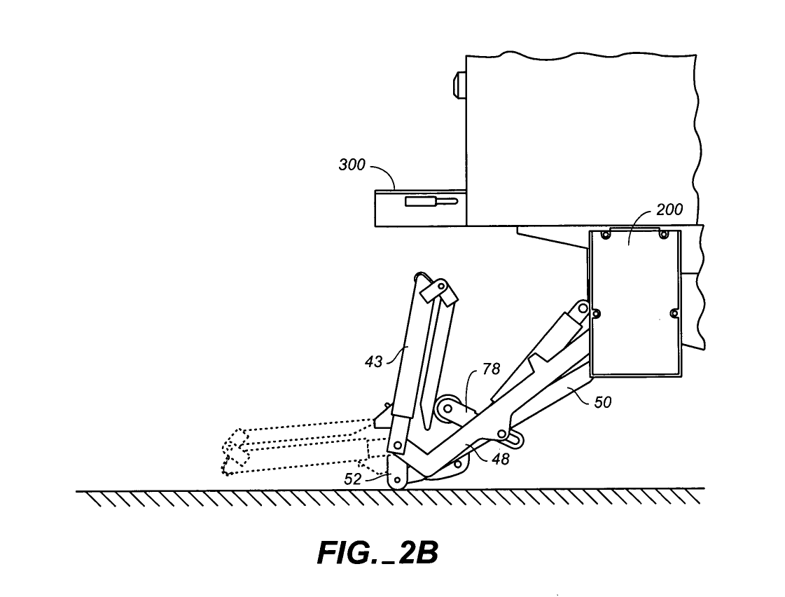

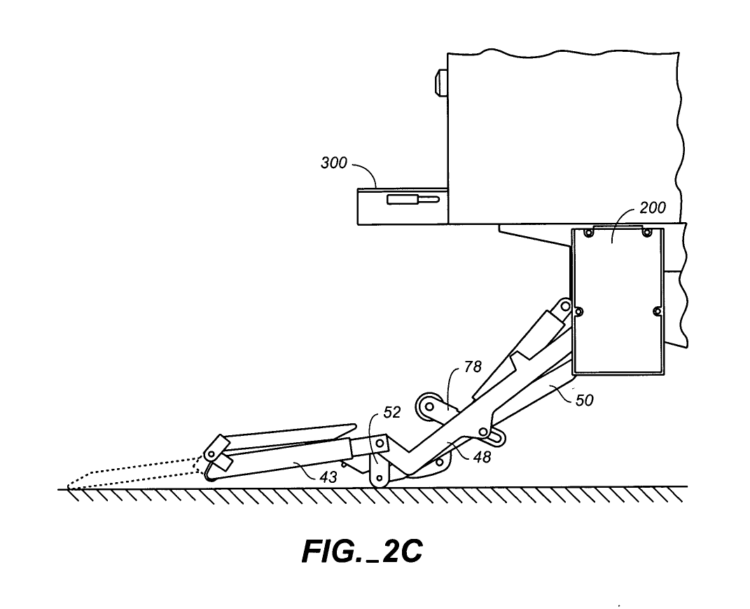

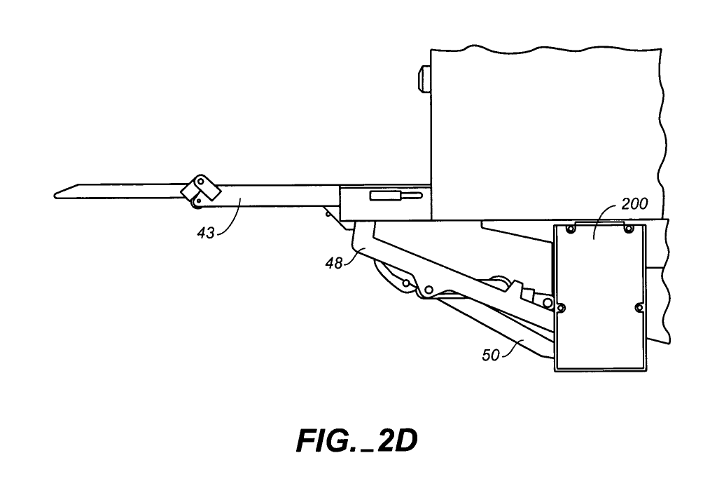

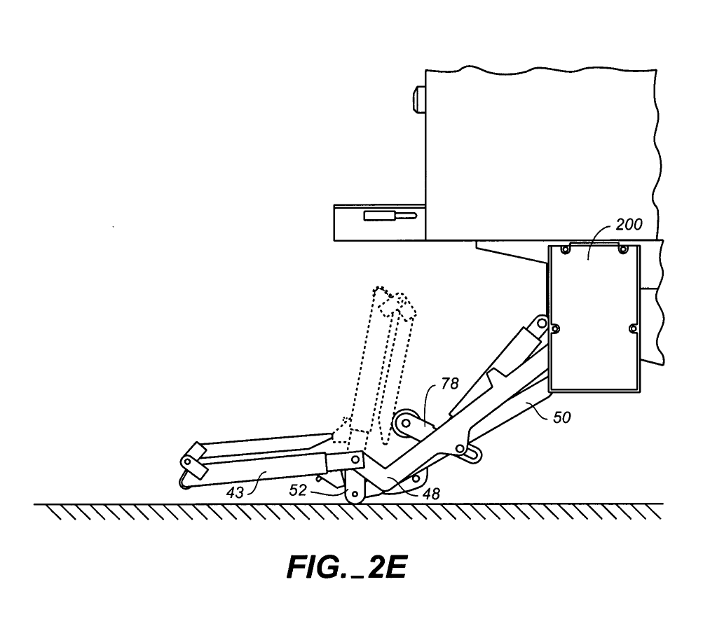

FIGS. 2A-2E show operation of one embodiment of a lift 100 of the present invention. FIG. 2A shows lift 100 in a fully raised position with platform 43 fully stowed. Platform 43 rests on platform stop 48/2. FIG. 2B shows lift 100 in a fully lowered position. Active opener arm 78 has pushed out platform 43 to where it can be easily reached by a user and unstowed for use. FIG. 2C shows lift 100 in a fully lowered position with platform 43 in the process of being unstowed. FIG. 2D shows lift 100 in a fully raised position with platform 48 unstowed. FIG. 2E shows lift 100 in a fully lowered position with platform 43 in the process of being stowed. Platform 43 is folded over so that it rests against active opener arm 78. When lift 100 is raised, active opener arm 78 lowers platform 43 towards upper arm 48. When lift 100 is fully raised, active opener arm 78 has lowered platform 43 to rest on platform stop 48/2. Active opener arm 78 is configured so that platform 43 does not contact the underside of vehicle 300 during stowing and unstowing.

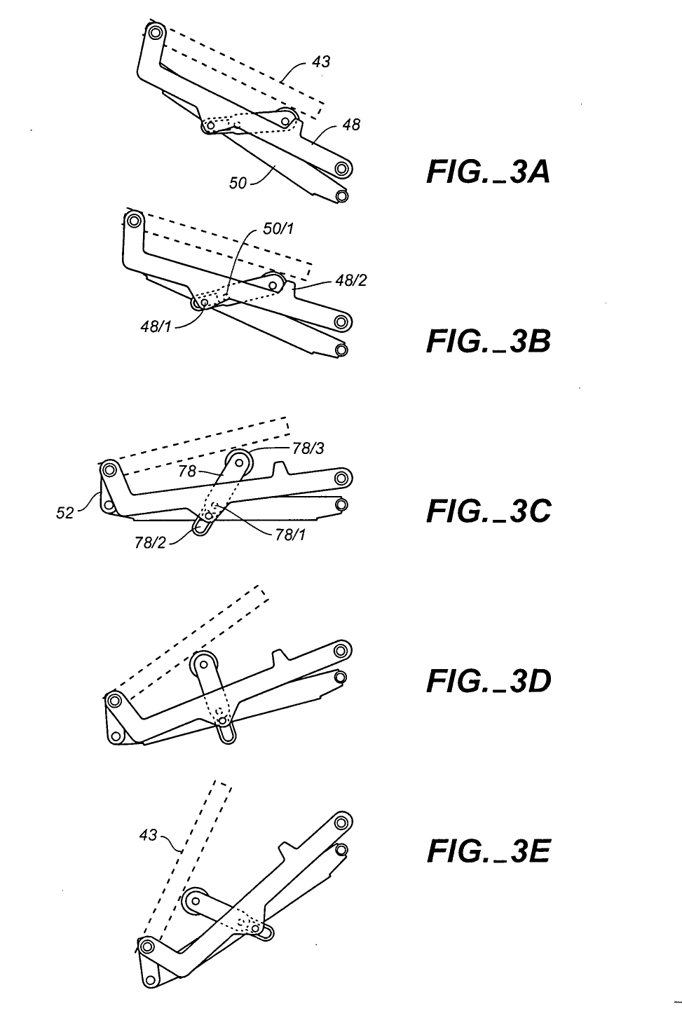

FIGS. 3A-3E show operation of lift 100 and active opener arm 78. Upper arm 48 and lower arm 50 are rotatably coupled to main frame 200 and shackle 52. The four points where upper arm 48 and lower arm 50 are coupled to main frame 200 and shackle 52 substantially form the four corners of a parallelogram.

Upper arm 48 includes an upper arm pin 48/1 and a platform stop 48/2. Lower arm 50 includes a lower arm pin 50/1. Upper arm 48 is configured so that upper arm pin 48/1 is lower than lower arm pin 50/1. Upper arm 48 may be configured as a “T” or a “L” shape, or a combination of both. In the embodiment shown, active opener arm 78 includes a pivot 78/1, a channel 78/2, and a roller 78/3.

Lower arm pin 50/1 of lower arm 50 is rotatably coupled to pivot 78/1 of active opener arm 78. Upper arm pin 48/1 of upper arm 48 is slidably engaged with channel 78/2 of active opener arm 78. In an alternative embodiment, lower arm pin 50/1 may be slidably engaged with channel 78/2 of active opener arm, and upper arm pin 48/1 rotatably coupled to pivot 78/1 of active opener arm. In other embodiments, active opener arm 78 may be slidably engaged with upper arm 48 or lower 50 with a sleeve bearing or with some other arrangement.

FIG. 3A shows upper arm 48 and lower arm 50 in a fully raised position with platform 43 in a fully stowed position. Platform 43 rests on platform stop 48/2 and active opener arm 78. As upper arm 48 and lower arm 50 lower in FIG. 3B, the relative positions of upper arm pin 48/1 and lower arm pin 50/1 cause active opener arm 78 to rotate, thus pushing platform 43 away from upper arm 48. As upper arm 48 and lower arm 50 continue to lower in FIGS. 3C and 3D, active opener arm 78 continues to push platform 43 away from upper arm 48. When upper arm 48 and lower arm 50 reach a fully lowered position in FIG. 3E, active opener arm 78 has pushed out platform 43 to where it can be easily reached by a user and unstowed for use.

Upper arm pin 48/1 slides in channel 78/2 and causes active opener arm 78 to rotate about lower arm pin 50/1. Active opener arm 78 may be configured to delay unstowing of platform 78, or to unstow platform 78 at a variable rate. For example, active opener arm 78 may be configured so that platform 43 stays in a substantially stowed position as lift 100 lowers, but then quickly pushes out platform 43 as lift 100 reaches the fully lowered position. Active opener arm 78 may also be configured to accommodate a wide range of vehicle bed heights. Active opener arm 78 may be adjustable in length, or have an adjustable roller 78/3.

Active opener arm 78 may also be actuated in other ways. For example, an additional actuator such as a hydraulic actuator may be used in conjunction with a sensor to actuate active opener arm 78 as lift 100 approaches the fully lowered position. As another example, a ground plate may be used to actuate active opener arm 78 as lift 100 approaches the ground and the ground plate comes into contact with the ground. More than one active opener arm 78 may also incorporated into the design of lift 100. An active opener arm 78 may also be used in conjunction with a static opener arm coupled to main frame 200. The static opener arm may push out platform 78 as lift 100 begins to lower, with active opener arm 78 completing the process as the lift 100 reaches the fully lowered position.

While the invention has been described in terms of some specific examples and in some specific embodiments, it will be clear that this invention is not limited to these specific examples and embodiments and that many changes and modified embodiments will be obvious to those skilled in the art without departing from the true spirit and scope of the invention as defined in the appended claims.

1. A lift comprising:
a parallelogram linkage;
a platform coupled to the parallelogram linkage, the platform capable of being stowed onto the parallelogram linkage; and
an active opener arm coupled to the parallelogram linkage, the active opener arm capable of assisting a user in stowing and unstowing the platform.

2. The lift of claim 1, wherein the active opener arm is capable of receiving the platform from the user when the platform is being stowed and lowering the platform onto the parallelogram linkage.

3. The lift of claim 1, wherein the active opener arm is capable of lifting the platform off of the parallelogram linkage when the platform is being unstowed and making the platform more accessible to the user.

4. The lift of claim 1, wherein the active opener arm is actuated mechanically by lowering or raising the parallelogram linkage.

5. The lift of claim 1, wherein the active opener arm is actuated by an actuator.

6. The lift of claim 1, wherein the active opener arm is actuated by a ground plate which actuates the active opener arm as the parallelogram linkage is lowered and the ground plate comes into contact with the ground.

7. A lift comprising:
a main frame having a lower frame coupling and an upper frame coupling;
a shackle having a lower shackle coupling and an upper shackle coupling;
a lower arm rotatably coupled to the lower frame coupling and the lower shackle coupling, the lower arm having a lower arm coupling, the lower arm coupling defining a horizontal plane;
an upper arm rotatably coupled to the upper frame coupling and the upper shackle coupling, the upper arm having an upper arm coupling, the upper arm coupling being lower than the horizontal plane defined by the lower arm coupling,
wherein the lower frame coupling, the upper frame coupling, the lower shackle coupling, and the upper shackle coupling substantially form corners of a parallelogram, and
wherein the upper arm and the lower arm have substantially parallel axes of rotations; and
an active opener arm rotatably coupled to the lower arm coupling, the active opener arm slidably coupled to the upper arm coupling, wherein rotating the upper arm and the lower arm causes the active opener arm to rotate about the lower arm coupling.

8. The lift of claim 7, further comprising:
a platform coupled to the shackle, the platform capable of being stowed to rest against the active opener arm.

9. The lift of claim 8, wherein lowering the lower and upper arms causes the active opener arm the push the platform away from the lower and upper arms.

10. The lift of claim 8, wherein raising the lower and upper arms causes the active opener arm to lower the platform towards the lower and upper arms.

11. A lift comprising:
means for carrying a load;
means for lowering and raising the load coupled to the means for carrying a load, the means for carrying a load capable of being stowed; and
means for assisting a user in stowing and unstowing the means for carrying a load.

12. A method for assisting in stowing and unstowing a platform of a lift, the lift having a parallelogram linkage, the platform being coupled to the parallelogram linkage, the platform capable of being stowed onto the parallelogram linkage, the method comprising:
providing an active opener arm coupled to the parallelogram linkage, the active opener arm being capable of receiving the platform from the user when the platform is being stowed and lowering the platform onto the parallelogram linkage, the active opener arm is capable of lifting the platform off of the parallelogram linkage when the platform is being unstowed and presenting the platform to the user.
